(19) United States
(12) Patent Application Publication
(10) Pub. No.: US 2026/0090626 A1
(43) Pub. Date: Apr. 2, 2026

(54) TOOL CARRYING HARNESS AND STRAP ASSEMBLY FOR ADJUSTING THE SAME

(71) Applicant: HUSQVARNA AB, Huskvarna (SE)

(72) Inventors: Martin JOHANSSON, Jonkoping (SE); Janarne WETTERHEIM, Jonkoping (SE)

(21) Appl. No.: 19/111,527

(22) PCT Filed: Oct. 11, 2023
(86) PCT No.: PCT/EP2023/078150

§ 371 Date: Mar. 13, 2025

(30) Foreign Application Priority Data
Oct. 12, 2022 (SE) 2251192-7

(51) Int. Cl. A45F 3/14; A01D 75/00

(52) U.S. Cl. CPC A45F 3/14; A01D 75/008; A45F 2003/144

(57) ABSTRACT

A harness (100/200) for carrying an outdoor power equipment device may include a back plate (110/210), a leg plate (260/310) to support the device responsive to attachment of the device to the leg plate (260/310), a chest buckle (170/270) operable to alternately enable donning and doffing of the harness (100/200), and an adjustable strap assembly (280/300) operably coupled to the back plate (110/210) and the chest buckle (170/270) to enable a carrying height of the leg plate (260/310) to be adjusted. The adjustable strap assembly (280/300) may include a strap portion (302) operably coupling the leg plate (260/310) to the back plate (110/210) at a selected one of a plurality of fixed anchoring points via an attachment toggle (308) disposed at a distal end of the first strap portion (302).

### TECHNICAL FIELD

Example embodiments generally relate to an outdoor power tool equipment harness and, more particularly, relate to a strap assembly for conferring adjustability and comfort when wearing the harness.

### BACKGROUND

Property maintenance tasks are commonly performed using various forms of outdoor power equipment that are configured for the performance of corresponding specific tasks. Some of those forms of outdoor power equipment are designed to be effective at performing the specific tasks in situations that could be relatively brief, or could take a long time including, in some cases, a full day of work. When operating outdoor power equipment for a long period of time, fatigue can play a role in the operation of the outdoor power equipment. Regardless of how long the operator uses the outdoor power equipment, it is important that the operator remains able to effectively maneuver the outdoor power equipment device to achieve the best possible results for the property maintenance tasks.

To help reduce the speed and severity of the onset of fatigue, operators may wear a harness that may better distribute the force felt by the operator from the weight of the outdoor power equipment. However, the fitment of the harness may determine the effectiveness of the harness at minimizing fatigue. The harness may not be a one-size-fits-all solution, and therefore some form of adjustment for the harness may be desired. However, a balance must be struck between ease of operation and security of operational settings, and between comfort and usability. Example embodiment may optimize a balance of these factors.

### BRIEF SUMMARY OF SOME EXAMPLES

Some example embodiments may provide for a harness for carrying an outdoor power equipment device may be provided. The harness may include a back plate, a leg plate to support the device responsive to attachment of the device to the leg plate, a chest buckle operable to alternately enable donning and doffing of the harness, and an adjustable strap assembly operably coupled to the back plate and the chest buckle to enable a carrying height of the leg plate to be adjusted. The adjustable strap assembly may include a first strap portion operably coupling the leg plate to the back plate at a selected one of a plurality of fixed anchoring points via an attachment toggle disposed at a distal end of the first strap portion. The adjustable strap assembly may also include a second strap portion that operably couples the leg plate to the chest buckle via an adjustable coupler that defines an infinite number of set positions for the carrying height of the leg plate.

According to another example embodiment, a harness for carrying an outdoor power equipment device may include a back plate, a leg plate to support the device responsive to attachment of the device to the leg plate, a chest buckle operable to alternately enable donning and doffing of the harness, and an adjustable strap assembly operably coupled to the back plate and the chest buckle to enable a carrying height of the leg plate to be adjusted. The adjustable strap assembly may include a strap portion operably coupling the leg plate to the back plate at a selected one of a plurality of fixed anchoring points via an attachment toggle disposed at a distal end of the first strap portion.

According to yet another example embodiment, a harness for carrying an outdoor power equipment device may include a back plate, a leg plate to support the device responsive to attachment of the device to the leg plate, a chest buckle operable to alternately enable donning and doffing of the harness, and an adjustable strap assembly operably coupled to the back plate and the chest buckle to enable a carrying height of the leg plate to be adjusted. The adjustable strap assembly may include a strap portion that operably couples the leg plate to the chest buckle via an adjustable coupler that defines an infinite number of set positions for the carrying height of the leg plate.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a rear view of a harness prior to addition of an adjustable strap assembly of an example embodiment;

FIG. 2 illustrates a schematic block diagram of a harness in accordance with an example embodiment;

FIG. 3 illustrates a perspective view of portions of a harness including the adjustable strap assembly of an example embodiment;

FIG. 4A illustrates a rear perspective view of a back plate of the harness in accordance with an example embodiment;

FIG. 4B illustrates a front perspective view of the back plate of the harness in accordance with an example embodiment;

FIG. 4C illustrates a back view of the back plate of the harness in accordance with an example embodiment;

FIG. 5A illustrates a perspective view of an anchoring aperture and attachment toggle in accordance with an example embodiment;

FIG. 5B illustrates rotation of the attachment toggle to align the attachment toggle for passage through the anchoring aperture in accordance with an example embodiment;

FIG. 5C illustrates a perspective view of the attachment toggle fully seated in the back plate in accordance with an example embodiment;

FIG. 6A illustrates a front view of a chest buckle in accordance with an example embodiment;

FIG. 6B illustrates the chest buckle with a strap portion coupled thereto for adjustment of a carrying height of a leg plate of the harness in accordance with an example embodiment;

FIG. 6C illustrates the strap portion transitioning to being locked or fixed in accordance with an example embodiment; and

FIG. 6D illustrates the strap portion at a fixed carrying height in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

In some example embodiments, an operator may wear a harness while actively operating outdoor power equipment. The harness may be utilized for operably coupling to outdoor power equipment that may be too heavy or otherwise cumbersome to effectively operate for extended periods of time. The harness may include at least one leg plate, hip pad or other contact pad structure that may separate the outdoor power equipment device from direct physical contact with the operator, while simultaneously engaging the device to enable the harness to support its weight. Furthermore, the nature of performing lawn care and maintenance tasks may often imply that anyone should be able to operate the outdoor power equipment, regardless of the operator's physical size and strength. In this regard, a standard harness may not properly fit all potential operators of the outdoor power equipment, even with a range of sizes built into the standard harness. Moreover, some users (regardless of size) may wish to carry the hip pad (and therefore also the device) at different heights for different jobs, or at different times.

Although many harnesses may be adjustable in some form, the changes are typically limited to only a single adjuster, which may slip over time, or to complicated modifications that may require tools. As such, it may be desirable to not only expand the range of sizes of the harness so that operators of all sizes may still wear the harness when operating outdoor power equipment, but to make the adjustability between supporting different users and different equipment heights very easy, and seamless. Thus, some example embodiments may provide a harness and strap assembly for the harness that can not only be adjusted easily (for comfort and/or tool carrying height), but which do not slip over time and in use.

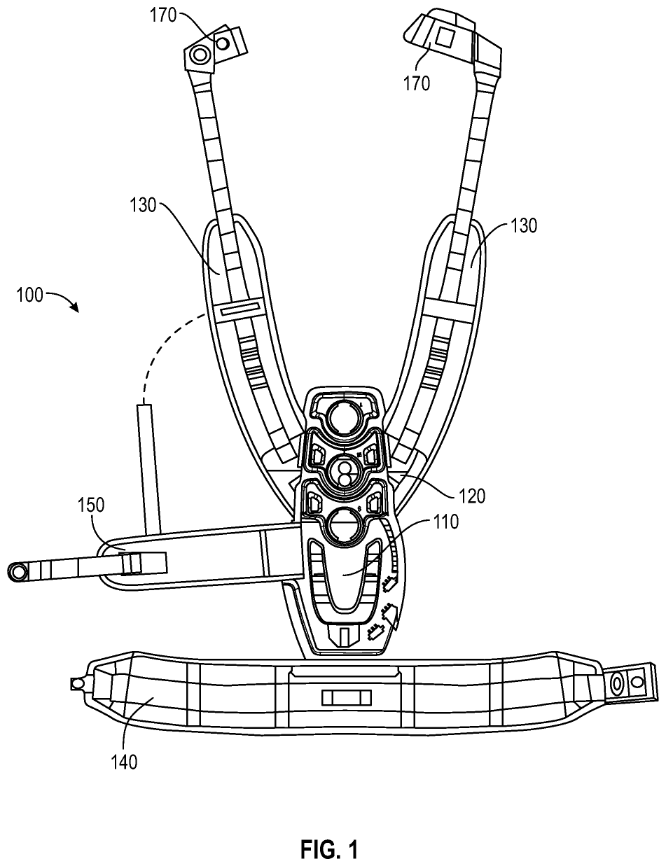

FIG. 1 is a rear view of a harness 100 prior to addition of a hip pad adjustment assembly of an example embodiment. As shown in FIG. 1, the harness 100 may include a back plate 110, a joint plate 120, a shoulder strap assembly 130, a belt 140, a side strap 150, and a chest buckle 170. The back plate 110 may be centrally located relative to the other components of the harness 100 such that the back plate 110 may serve as a base to which the other components may be operably coupled. The back plate 110 may also play an integral role in supporting the operator's back when the harness 100 is being worn and an outdoor power equipment device is in use. The joint plate 120 may operably couple the back plate 110 to the shoulder strap assembly 130 at one of a plurality of selected joint locations. Accordingly, the shoulder strap assembly 130 may be configured to extend around, and rest on top of, an operator's shoulders. The joint plate 120 may give the operator the ability to move in a full range of motion by pivotably operably coupling the shoulder strap assembly 130 to the back plate 110. In this regard, as the operator wears the harness 100 and operates the outdoor power equipment device, the operator's shoulders may move responsive to moving the device. The pivotable operable coupling between the joint plate 120 and the back plate 110 allows the operator to make such movements without the harness 100 restricting the operator and also without the harness 100 coming off the operator. In some embodiments, it may be possible to adjust the position at which the joint plate 120 operably couples to the back plate 110, which may accordingly alter the effective size of the harness 100.

The back plate 110 may also be operably coupled to the belt 140. The belt 140 may be configured to secure to an operator's waist when the operator is wearing the harness 100. In this regard, the belt 140 may distribute some of the load force from the weight of the outdoor power equipment off of the operator's shoulders, so as to minimize the onset of operator fatigue when using the outdoor power equipment for an extended period of time. The back plate 110 may also be operably coupled to the side strap 150, which may be configured to operably couple to the back plate 110 to one side of the shoulder strap assembly 130 (e.g., on a side opposite the side at which the outdoor power equipment device is directly or indirectly supported (e.g., via a hook assembly disposed on the leg plate or hip pad). The chest buckle 170 includes two parts that buckle together, but are shown unbuckled in FIG. 1.

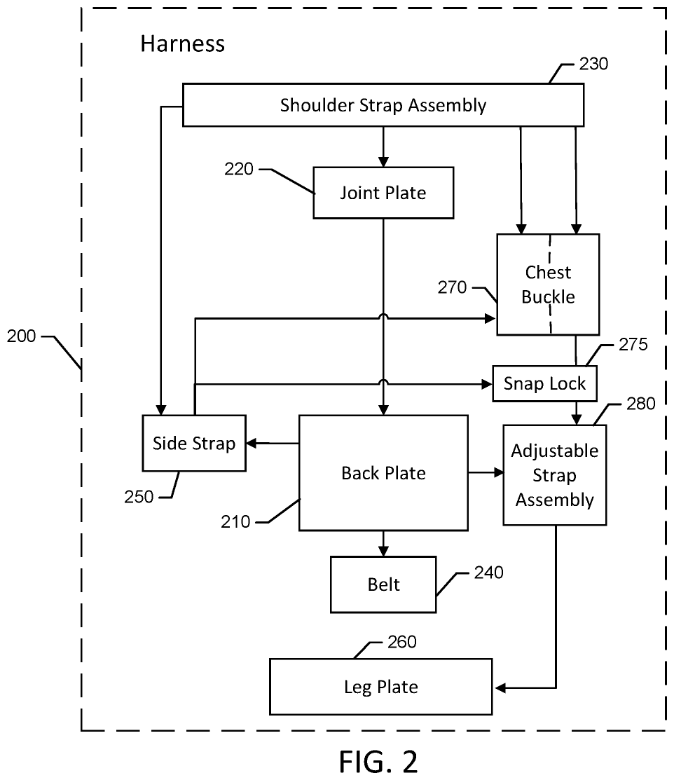

FIG. 2 illustrates a schematic block diagram of a harness 200 in accordance with an example embodiment. The harness 100 detailed in FIG. 1 may be an example of the harness 200 described herein. As shown in FIG. 2, the harness 200 may include a back plate 210, a joint plate 220, a shoulder strap assembly 230, a belt 240, a side strap 250, and a chest buckle 270, which may have similar structure and function as the components described in reference to FIG. 1 above. The harness 200 may also include a leg plate 260 (or hip pad) which may be operably coupled to both the back plate 210, the chest buckle 270 and the side strap 250 (or at least one of the shoulder straps of the shoulder strap assembly 230). In an example embodiment, the side strap 250 may be operable coupled to the chest buckle 270 or a strap of the adjustable strap assembly 280 via a snap lock 275. In some embodiments, the leg plate 260 may be configured to rest along one side (e.g., right or left) of the operator to provide a padded barrier between the outdoor power equipment device and the leg or hip of the operator on the corresponding side. The leg plate 260 may have a hook or other device for supporting the outdoor power equipment device. In this regard, the operator may have additional protection from the outdoor power equipment device, especially for an extended period of time, and weight of the device.

The harness 200 may also include an adjustable strap assembly 280 that operably couples the chest buckle 270, the back plate 210, and the leg plate 260 together to achieve adjustable height settings for the leg plate 260. For example, the leg plate 260 may be configured to be slidable along the adjustable strap assembly 280. The chest buckle 270 may be operably coupled to the shoulder strap assembly 230 and, in some cases, may be supported from above on each lateral side thereof by respective right and left straps of the shoulder strap assembly 230. The chest buckle 270 may include a buckle or other releasable component to enable left and right portions of the chest buckle 270 to be either connected to each other (e.g., when in use and being worn for use) and separated from each other (e.g., to permit donning and doffing the harness 200 by the operator), for example, along the dashed line perforation shown in FIG. 2.

The chest buckle 270 may in turn be operably coupled to the leg plate 260, along with the back plate 210, via adjustable strap assembly 280. Moreover, in an example embodiment, the adjustable strap assembly 280 may be operably coupled to each of the chest buckle 270 and the back plate 210 in an adjustable manner so that both the operable coupling of the adjustable strap assembly 280 to the back plate 210 and to the chest buckle 270 are adjustable without tools.

In an example embodiment, the adjustable strap assembly 280 may be adjustably attachable to the back plate 210 at one of a plurality of selectable fixed anchoring points. Thus, the adjustment of the adjustable strap assembly 280 to the back plate 210 may generally be made with the harness 200 doffed, and before the harness 200 is donned. In this regard, the operator may select one of the selectable fixed anchoring points and operably couple the adjustable strap assembly 280 to the back plate 210 at the selected one of the selectable fixed anchoring points. In some cases, each of the selectable fixed anchoring points may correlate to a different height for carriage of the leg plate 260 (and therefore also for carriage of the device being supported by the leg plate 260). As will be explained below in greater detail, the adjustable strap assembly 280 may include an attachment toggle that operably couples the adjustable strap assembly 280 to the back plate 210 at the selected one of the selectable fixed anchoring points.

The adjustable strap assembly 280 may also be adjustably attachable to the chest buckle 270. Since the chest buckle 270 may be operably coupled at top portions thereof to the shoulder strap assembly 230, the location of the adjustable attachment to the adjustable strap assembly 280 may be at a bottom portion of the chest buckle 270 either in the middle, or at the right or left side of the chest buckle 270. In an example in which the leg plate 260 is worn on the right side of the operator (e.g., against the right hip or right leg of the operator), the chest buckle 270 may be operably coupled to the shoulder strap assembly 230 on the same side (e.g., the right side from the perspective of the operator). The adjustable strap assembly 280 may be adjustable at an infinite number of locations with respect to the chest buckle 270 instead of the discrete number of selectable fixed positions that characterize the adjustable nature of the connection to the back plate 210.

Accordingly, it can be appreciated that the leg plate 260 is adjustable in height (along the operator's leg or hip) based on repositioning of the adjustable strap assembly 280 connection to either or both of the chest buckle 270 (which has infinite adjustability over a range defined by the length of an adjustment strap of the adjustable strap assembly 280) and the back plate 210 (which has a fixed number of discrete anchor points). In an example embodiment, the discrete anchor points of the back plate 210 may correspond to respective different distinct carrying heights associated with different jobs (e.g., a grass cutting lower position, and a forest clearing higher position), where the decision on adjustment, while being made without tools, is nevertheless typically made before donning the harness 200. Meanwhile, the infinite adjustability of the chest buckle 270 connection may allow for comfort adjustments to be made that can be made while the operator is wearing the harness 200, and therefore after donning the harness 200. However, the infinitely adjustable nature of the connection between the chest buckle 270 and the leg plate 260 means that the chest buckle 270 can also be used to change height for different jobs (including changing jobs) without doffing the harness 200.

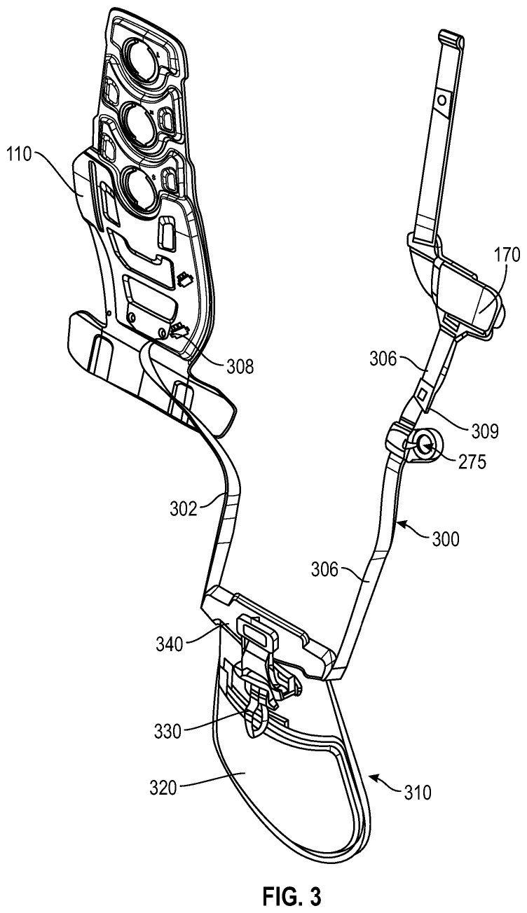

FIG. 3 illustrates a perspective view of an adjustable strap assembly 300, which is an example of the adjustable strap assembly 280 described above in reference to FIG. 2. The adjustable strap assembly 300 is provided to operably couple the back plate 110 and chest buckle 170 of FIG. 1 to a leg plate 310 (which is an example of leg plate 260 of FIG. 2). The adjustable strap assembly 300 may include a first strap portion 302, a second strap portion 304, an adjustment strap 306, and an attachment toggle 308, which may be operably coupled to the first strap portion 302 at a distal end thereof.

The leg plate 310 may include a pad portion 320, a hook 330 and a strap interface 340. The pad portion 320 may be made of leather, webbed material, or any other durable material that can withstand contact with and movement of the outdoor power equipment device as it is supported by the hook 330 and moved (typically pivoted) to facilitate cutting operations by the device. The strap interface 340 provides an interface to the adjustable strap assembly 280 to define different carrying heights for the leg plate 310 and consequently for the outdoor power equipment device supported on the hook 330.

In some embodiments, the first strap portion 302, the second strap portion 304, and the adjustment strap 306 may all be portions of the same unitary strap, belt or webbing. In such examples, portions of the unitary strap that correspond to each of the first strap portion 302, the second strap portion 304, and the adjustment strap 306, and thus boundaries therebetween, may dynamically change and depend upon the position of the leg plate 310. Thus, for example, the strap interface 340 may slidably engage with the unitary strap and, when resting on the leg or hip of the operator in a set position, the portion of the unitary strap that extends from the attachment toggle 308 to the strap interface 340 may be considered to be the first strap portion 302. The portion of the unitary strap that extends from the strap interface 340 to the chest buckle 170 may be considered the second strap portion 304. Finally, the portion of the unitary strap that extends through and outside the chest buckle 170 to a free end 309 of the unitary strap may be considered to be the adjustment strap 306.

In alternative embodiments, the first strap portion 302 may have a fixed connection to the strap interface 340, and therefore a fixed length. In such alternative embodiments, the second strap portion 304 may also have a fixed connection to the strap interface 340. However, even in such an example, the boundary between the second strap portion 304 and the adjustment strap 306 may change in the manner described above.

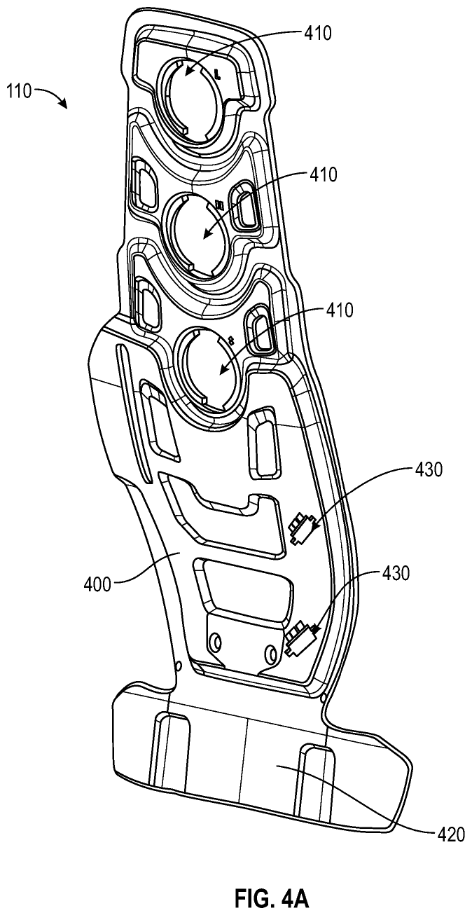

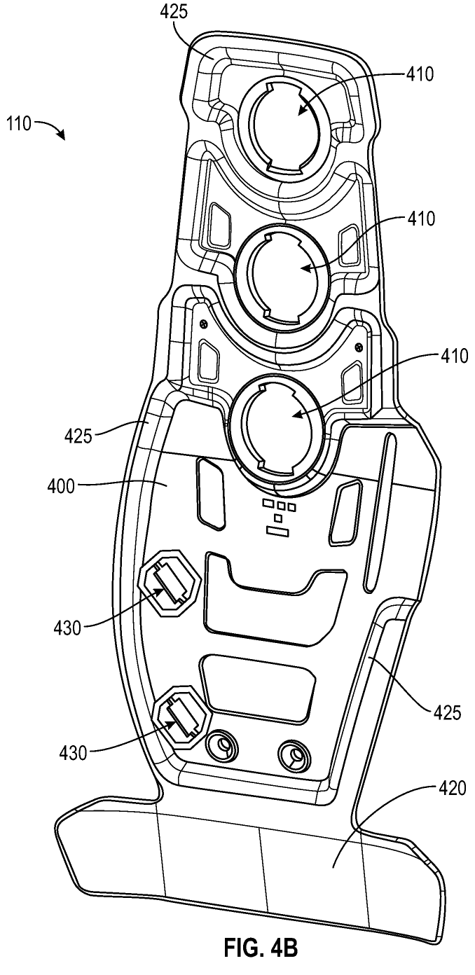

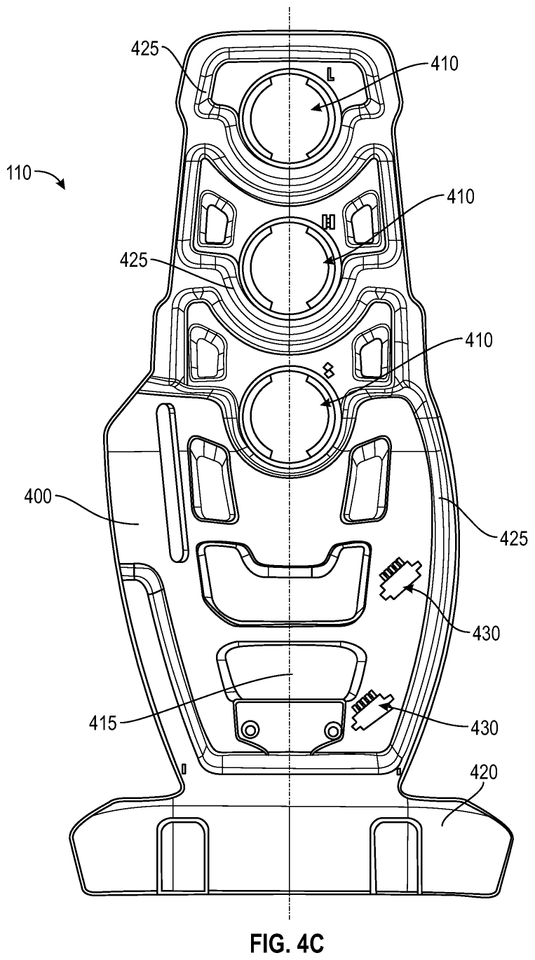

FIGS. 4A and 4B show front and rear perspective views of the back plate 110 of an example embodiment in more detail. FIG. 4C shows a back view of the back plate 110, which shows the side of the back plate 110 that faces away from the operator when the harness 100 is being worn. In this regard, the back plate 110 of this example may include a plate member 400, and the plate member 400 may include a plurality of retention orifices 410. Each of the retention orifices 410 may be configured to operably couple with the joint plate 120 of FIG. 1. In some embodiments, the plate member 400 may include three retention orifices 410 disposed along a longitudinal centerline 415 of the plate member 400 to define three different attachment points for the joint plate 120. In such cases, each retention orifice 410 may have a corresponding size (either Small, Medium, or Large) to which the harness 100 can be configured, depending on which retention orifice 410 the joint plate 120 is operably coupled to. The retention orifices 410 may be aligned along the longitudinal centerline 415 of the plate member 400 so that the back plate 110 remains centered in a middle of the operator's back in order to better distribute the weight of the outdoor power equipment device when in use.

The plate member 400 may also include a waist portion 420 that may be configured to operably couple to the belt 140. The plate member 400, and the waist portion 420, may be curved so that the back plate 110 conforms to the natural shape of the operator's back. In some cases, the plate member 400 may further include a plurality of structural cutouts strategically disposed at various locations on the back plate 110 as a method of saving weight and improving cooling of the operator without compromising on the structural integrity of the back plate 110. Accordingly, the harness 100 may provide the best possible fit and comfort for the operator and may therefore be more effective in minimizing the fatigue levels of the operator due to the extended use of the outdoor power equipment device.

In some embodiments, the plate member 400 may be formed from a plastic or composite material via an injection molding process in order to minimize manufacturing costs as well as provide a lightweight, yet strong, material to meet the specific needs of the back plate 110. Injection molding may facilitate forming the cutouts mentioned above, and the curved shapes where appropriate. In addition to the curvature of the plate member 400, the plate member 400 of some embodiments may also include various reinforcement ridges 425 to increase the strength of the back plate 110. Examples of such reinforcement ridges 425 can be seen formed at peripheral edges of the plate member 400, and extending proximate to the retention orifices 410.

In an example embodiment, the plate member 400 may also have a plurality of anchoring apertures 430 to which the first strap portion 302 may be operably coupled via the attachment toggle 308. The locations of the anchoring apertures 430 may be determined based on the type of jobs expected to be performed while wearing the harness 100, and may be selected to create different carrying heights (e.g., for the leg plate 310, and consequently also for the outdoor power equipment device supported on the hook 330).

As can be seen from FIG. 4C, the depicted example includes two instances of the anchoring apertures 430 that are placed at different heights with one being lower than the other. In an example embodiment, the lower positioned instance of the anchoring apertures 430 may be for one job (e.g., grass cutting), which may require a lower carriage of the outdoor power equipment device supported on the hook 330. The higher positioned instance of the anchoring apertures 430 may be for a different job (e.g., forestry trimming or cutting), which may require a higher carriage of the outdoor power equipment device supported on the hook 330. Notably, rather than being disposed equidistant from the longitudinal centerline 415, which may otherwise be expected, the anchoring apertures 430 are instead located equidistant from the peripheral edges of the plate member 400 to thereby disposed the anchoring apertures 430 equidistant from the closest reinforcement ridges 425 thereto, for improved strength and stability.

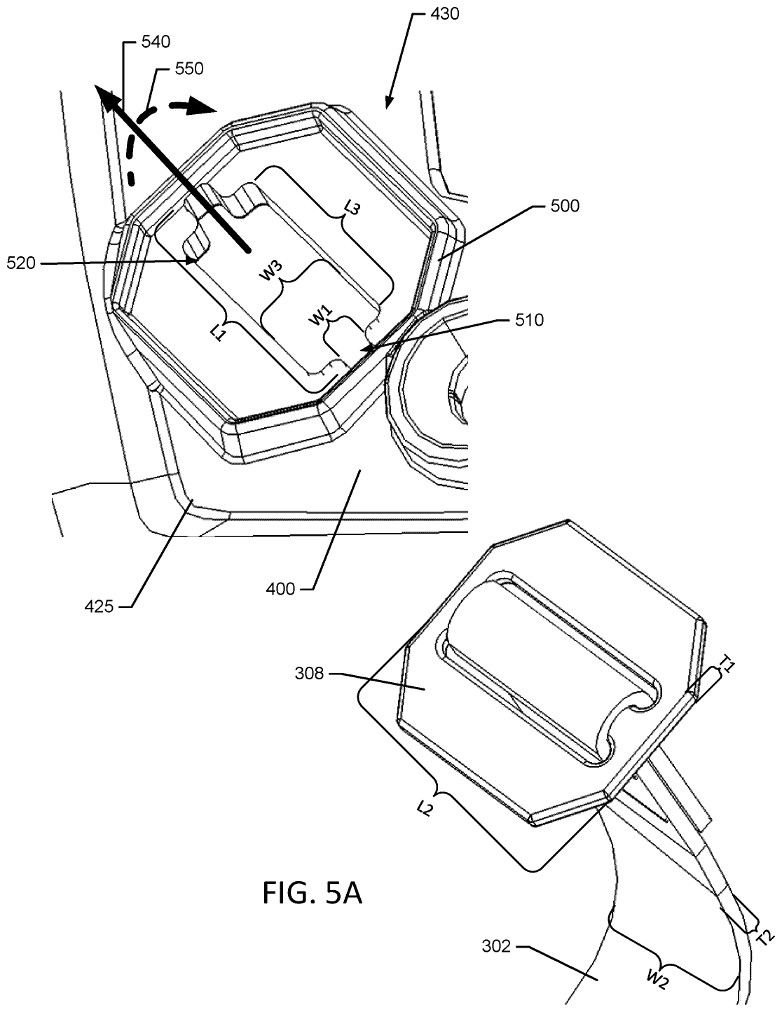

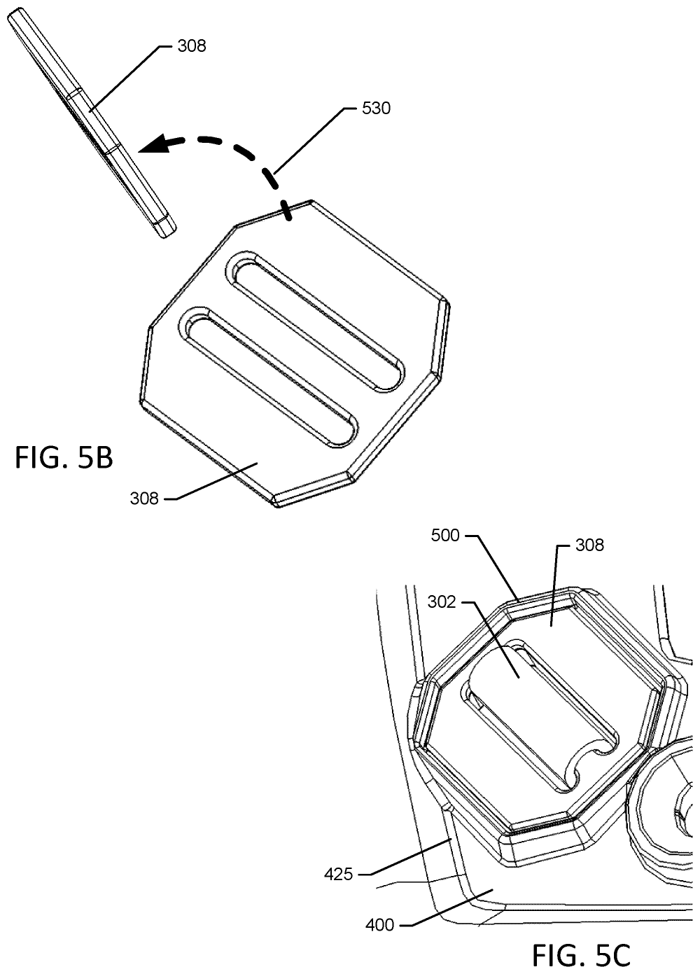

Further improvements in design that enhance the durability and function of the anchoring apertures 430 can be seen in FIGS. 5A-5C. In this regard, FIG. 5A shows a close-up perspective view of one of the anchoring apertures 430 as seen in FIG. 4B (i.e., from the side that faces the back of the operator). This view shows several structures of the anchoring apertures 430 that provide improved performance. FIG. 5B illustrates the attachment toggle 308 in isolation to show how the attachment toggle 308 is operated to interact with a selected one of the anchoring apertures 430. Meanwhile, FIG. 5C shows the attachment toggle 308 fully seated in the selected one of the anchoring apertures 430.

As shown in FIGS. 5A and 5C, the anchoring apertures 430 are each surrounded on the side of the plate member 400 that faces the operator by a retaining wall 500. The retaining wall 500 is formed by a series of ridges extending away from the surface of the plate member 400 having a height that is substantially equal to a thickness (T1) of the attachment toggle 308. Moreover, the retaining wall 500 is shaped to extend around a periphery of the attachment toggle 308 to both guide and retain the attachment toggle 308 in the location proximate to the plate member 400 and surrounded on peripheral edges by the retaining wall 500. However, the retaining wall 500 further reinforces the plate member 400 in this region to enhance the durability of the back plate 110 and its ability to bear the weight of the outdoor power equipment device that is suspended from the hook 330, and borne at least in part by the portion of the plate member 400 that surrounds the anchoring apertures 430.

The anchoring apertures 430 each also have a unique functional shape including a toggle passage 510 and a strap passage 520 that extends on opposing lateral sides of the toggle passage 510. The toggle passage 510 has a length (L1) that is slightly longer than a corresponding length (L2) of the attachment toggle 308. The length (L1) of the toggle passage 510 may extend in a direction that forms an acute angle with respect to the longitudinal centerline 415 in order to orient the first strap portion 302 to extend smoothly in the direction of the leg plate 310 instead of needing to twist to extend toward the leg plate 310, which may create discomfort for the operator (which would be the case if the toggle passage 510 was either parallel or perpendicular to the longitudinal centerline 415). The toggle passage 510 has a width (W1) that is slightly larger than the thickness (T1) of the attachment toggle 308. This arrangement ensures that the attachment toggle 308 may only pass through the toggle passage 510 when properly aligned with the toggle passage 510 so that it is virtually impossible to have the attachment toggle 308 inadvertently disconnect from the anchoring aperture 430 after being attached thereto. Meanwhile, the strap passage 520 has a length (L3) that is slightly longer than a width (W2) of the first strap portion 302. The strap passage 520 has a width (W3) that is at least double a thickness (T2) of the first strap portion 302. This arrangement ensures that the first strap portion 302 can have freedom of movement even when the attachment toggle 308 is fully seated in the anchoring aperture 430.

To adjust the carrying height of the leg plate 310, the operator may bring the first strap portion 302 and attachment toggle 308 proximate to the back plate 110, and particularly proximate to a selected one of the anchoring apertures 430, as shown in FIG. 5A. The operator may then toggle, or rotate the attachment toggle 308 as shown by arrow 530 in FIG. 5B. The rotated attachment toggle 308 may then be passed through the toggle passage 510 in the direction of arrow 540 in FIG. 5A. Notably, due to the size and shape of the toggle passage 510, the attachment toggle 308 will only fit through the toggle passage 510 when rotated and aligned with the toggle passage 510. However, the first strap portion 302 would otherwise bind in the toggle passage 510 if not for the strap passage 520. Thus, the combination of sizing and shaping of the two passages combined enables the easy operation, but secure retention, that is provided by the attachment toggle 308. After the attachment toggle 308 has been passed through the toggle passage 510 in the rotated state, the attachment toggle 308 may then be toggled or rotated in the direction of arrow 550 in FIG. 5A to allow the attachment toggle 308 to align with and become fully seated within the retaining wall 500 as shown in FIG. 5C where, again, the sizing and shaping of the retaining wall 500 facilitates secure retention of the attachment toggle 308 during use.

The attachment toggle 308 described above provides for different fixed anchoring points that can be selected based on different jobs or uses for the outdoor power equipment device supported at the leg plate 310. However, as noted above, the attachment toggle 308 may generally be adjusted when the harness 100 is doffed. Meanwhile, the chest buckle 170 may provide for infinite adjustment while the harness 100 is donned, which may be for comfort or job type.

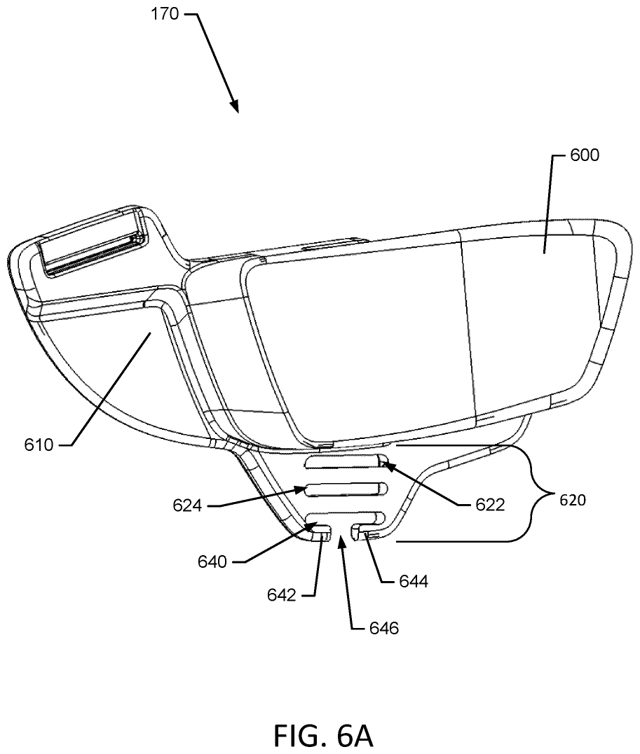

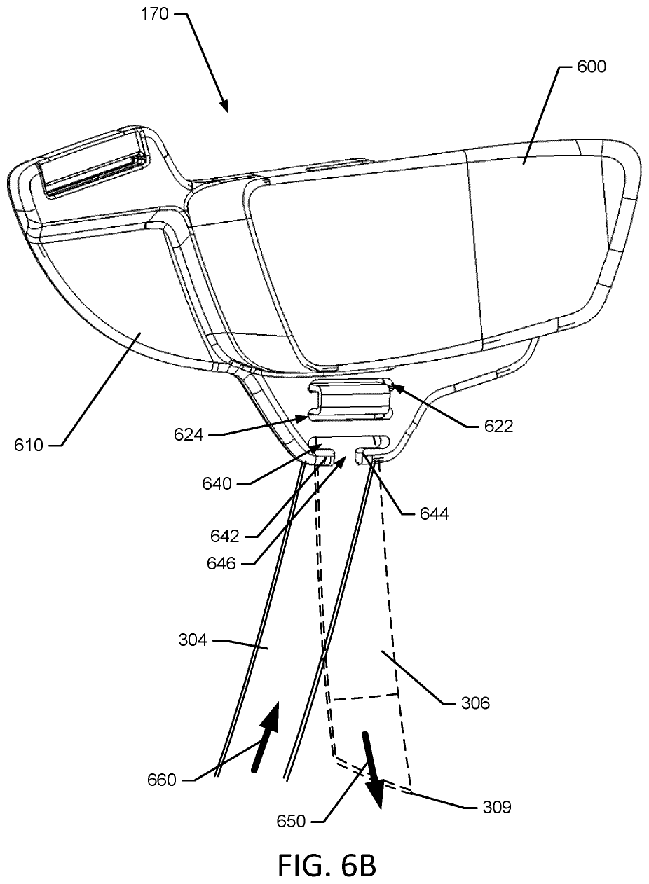

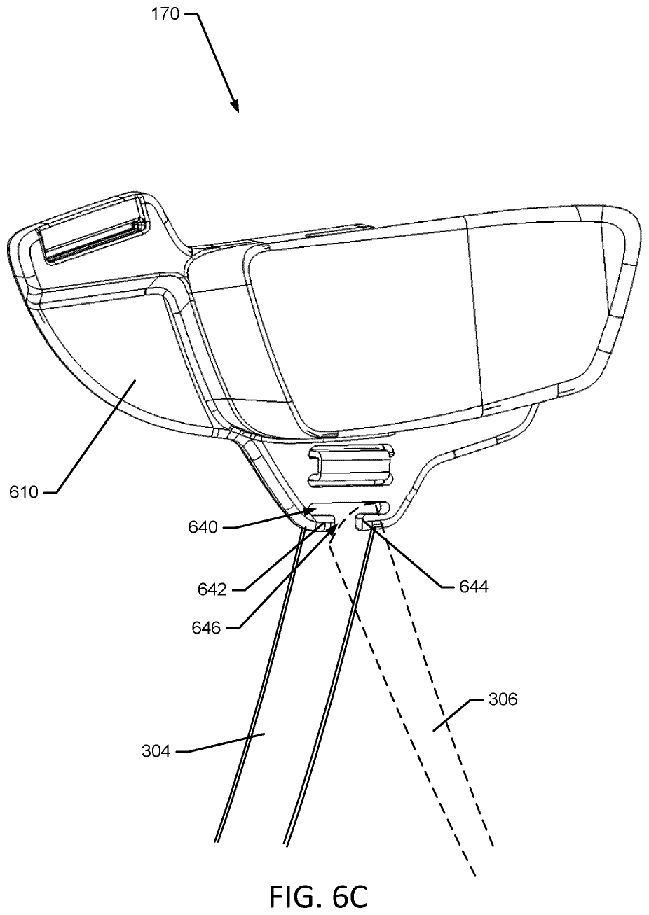

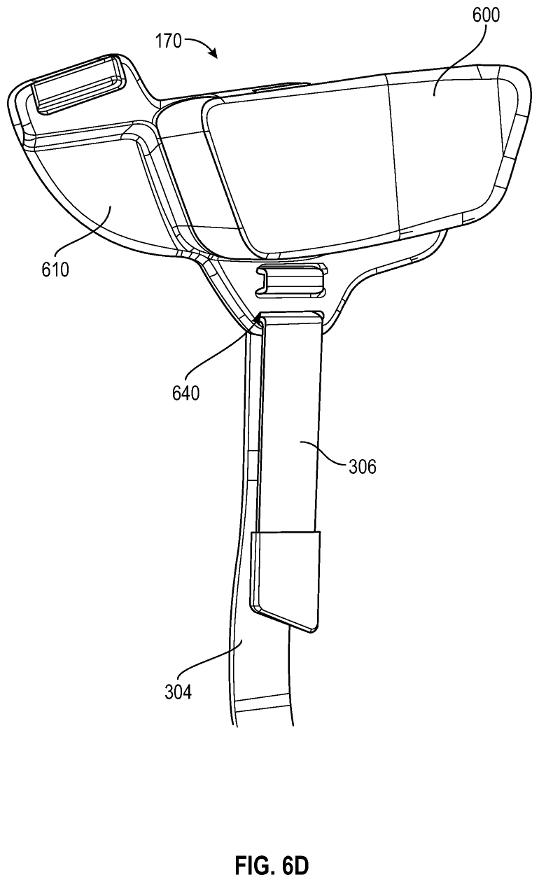

Turning now to FIGS. 6A, 6B, 6C and 6D, which show the chest buckle 170 in various different states relative to the second strap portion 304, operation of the chest buckle 170 of an example embodiment will be described in greater detail. In this regard, the chest buckle 170 of FIG. 6A is shown from a front view with the second strap portion 304 and the adjustment strap 306 removed, whereas FIGS. 6B, 6C and 6D show the second strap portion 304 and the adjustment strap 306 in various different states.

As shown in FIG. 6A, the chest buckle 170 may include a first buckle portion 600 and a second buckle portion 610 that are alternately capable of being clasped together or released from each other. Thus, for example, one of the first or second buckle portions 600 and 610 may be a male buckle portion, and the other of the second or first buckle portions 610 and 600 may be a female buckle portion, and the male and female buckle portions can alternately be attached to each other or disconnected from each other. In the depicted example, a button may be disposed on a back side of the chest buckle 170 (i.e., a side of the chest buckle 170 that faces the operator, and is therefore not visible in FIG. 6A) to release the attachment between the first and second buckle portions 600 and 610.

One of the first or second buckle portions 600 and 610 may also include an adjustable coupler 620, which may be infinitely adjustable, as noted above. The adjustable coupler 620 may be formed at a bottom edge of the chest buckle 170 to interface with the adjustable strap assembly 300. More particularly, the adjustable coupler 620 may interface with the second strap portion 304 and define the interface or boundary between the second strap portion 304 and the adjustment strap 306.

The adjustable coupler 620 may include a first strap passage 622 and a second strap passage 624 through which the second strap portion 304 is slid or passed in opposite directions to define a slide interface (e.g., tri-glide slide or webbing slide). The slide interface may provide a slidable interface for positioning the carrying height of the leg plate 310. In this regard, a typical tri-glide slide or webbing slide is able to hold a set position, but allow the set position to be adjusted when the operator pulls on the free end of strapping, webbing or in this case the adjustment strap 306. This type of adjustable coupler is commonly employed in many similar contexts. However, although generally easy to use, and often sufficient to hold the set position, such a tri-glide slide or webbing slide may slip over time in many situations, and particularly in situations where the supported load is heavy, or moves a lot. Since that is precisely the use can in many scenarios in which the harness 100 is expected to be employed, an improvement upon the typical tri-glide or webbing slide is desirable for this context. Accordingly, the adjustable coupler 620 of some example embodiments may further include a locking slot 640 that can retain the adjustment strap 306 after passing therethrough in a direction opposite the direction of travel of through the second strap passage 624.

The locking slot 640 may be formed spaced apart from the second strap passage 624 by the same distance that separates the second strap passage 624 from the first strap passage 622. The lengths and widths of each of the first strap passage 622, the second strap passage 624 and the locking slot 640 may all be substantially the same, which may be slightly larger than the width and thickness of the second strap portion 304, respectively. The locking slot 640 may be defined by a first locking arm 642 that is spaced apart from and faces a second locking arm 644. The spacing between the first and second locking arms 642 and 644 may define a slip passage 646 into which the adjustment strap 306 can be passed to lock the set position of the adjustable coupler 620 relative to the second strap portion 304.

In this regard, FIG. 6B shows the second strap portion 304 passed through the first and second strap passages 622 and 624 of the adjustable coupler 620, but the adjustment strap 306 (shown in dashed lines in FIG. 6B) is not passed through the locking slot 640. In this state, the adjustment strap 306 may be pulled by the operator in the direction of arrow 650 to pass more of the second strap portion 304 toward and through the tri-glide slide or webbing slide formed by the first and second strap passages 622 and 624 (e.g., in the direction of arrow 660). When a desired set position defining the desired carrying height of the leg plate 310 is reached, the operator may first pass one edge of the adjustment strap 306 through the slip passage 646 and behind one of the locking arms as shown in FIG. 6C. Then the other edge of the adjustment strap 306 may be passed through the slip passage and placed behind the other one of the locking arms to place the adjustment strap 306 in the locking slot 640 (with both edges behind a corresponding one of the first and second locking arms 642 and 644) to lock the set position so that no slippage will occur in the carrying height during use of the outdoor power equipment device.

Some example embodiments may provide a harness for carrying an outdoor power equipment device. The harness may include a back plate, a leg plate to support the device responsive to attachment of the device to the leg plate, a chest buckle operable to alternately enable donning and doffing of the harness, and an adjustable strap assembly operably coupled to the back plate and the chest buckle to enable a carrying height of the leg plate to be adjusted. The adjustable strap assembly may include a first strap portion operably coupling the leg plate to the back plate at a selected one of a plurality of fixed anchoring points via an attachment toggle disposed at a distal end of the first strap portion. The adjustable strap assembly may also include a second strap portion that operably couples the leg plate to the chest buckle via an adjustable coupler that defines an infinite number of set positions for the carrying height of the leg plate.

The harness of some embodiments may include additional features, modifications, augmentations and/or the like to achieve further objectives or enhance performance of the harness. The additional features, modifications, augmentations and/or the like may be added in any combination with each other. Below is a list of various additional features, modifications, and augmentations that can each be added individually or in any combination with each other. For example, the adjustable coupler may include a tri-glide slide or webbing slide portion and a locking slot. In an example embodiment, the locking slot may include a first locking arm and a second locking arm separated from each other by a slip passage, and the second strap portion of the adjustable strap assembly may be slidable through the tri-glide slide or webbing slide portion to change the carrying height of the leg plate by pulling an adjustment strap at a distal end of the second strap portion when the adjustment strap is not retained in the locking slot and the carrying height may be fixed when the adjustment strap is retained in the locking slot. In some cases, each of the fixed anchoring points may include an anchoring aperture defining a different carrying height corresponding to a different job type performed by the device. In an example embodiment, the anchoring aperture may include a toggle passage having a length and width slightly larger than a length and thickness of the attachment toggle, respectively. The anchoring aperture may also include a strap passage disposed on opposing lateral sides of the toggle passage. The strap passage may have a length slightly larger than a width of the first strap portion and a width slightly larger than a thickness of the first strap portion. In some cases, the length of the toggle passage extends in a direction that forms an acute angle with respect to a longitudinal centerline of the back plate. In an example embodiment, the attachment toggle is rotated to pass through the toggle passage and un-rotated after passing through the toggle passage to retain the attachment toggle at the anchoring aperture. In some cases, the back plate may include a plate member and the anchoring aperture may be formed at a portion of the plate member. The back plate may also include a retaining wall formed by a series of ridges extending away from a surface of the plate member to a height that is substantially equal to a thickness of the attachment toggle. The retaining wall may be shaped to extend around a periphery of the attachment toggle to guide and retain the attachment toggle proximate to the plate member. In an example embodiment, the fixed anchoring points may include a first anchoring aperture disposed a first distance from a longitudinal centerline of the back plate and a second anchoring aperture disposed a second distance from the longitudinal centerline, where the first distance is less than the second distance. In some cases, the attachment toggle may be disposed at the selected one of a plurality of fixed anchoring points while the harness is doffed by an operator, and the adjustable coupler may be operable while the harness is donned by the operator.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A harness for carrying an outdoor power equipment device, the harness comprising:
a back plate;
a leg plate to support the device responsive to attachment of the device to the leg plate;
a chest buckle operable to alternately enable donning and doffing of the harness; and
an adjustable strap assembly operably coupled to the back plate and the chest buckle to enable a carrying height of the leg plate to be slidably adjusted,
wherein the adjustable strap assembly comprises a first strap portion operably coupling the leg plate to the back plate at a selected one of a plurality of fixed anchoring points via an attachment toggle disposed at a distal end of the first strap portion, and
wherein the adjustable strap assembly comprises a second strap portion that operably couples the leg plate to the chest buckle via an adjustable coupler that defines an infinite number of set positions for the carrying height of the leg plate.

2. The harness of claim 1, wherein the adjustable coupler comprises a tri-glide slide or webbing slide portion and a locking slot.

3. The harness of claim 2, wherein the locking slot comprises a first locking arm and a second locking arm separated from each other by a slip passage, and
wherein the second strap portion of the adjustable strap assembly is slidable through the tri-glide slide or webbing slide portion to change the carrying height of the leg plate by pulling an adjustment strap at a distal end of the second strap portion when the adjustment strap is not retained in the locking slot and the carrying height is fixed when the adjustment strap is retained in the locking slot.

4. The harness of claim 1, wherein each of the fixed anchoring points comprises an anchoring aperture defining a different carrying height corresponding to a different job type performed by the device.

5. The harness of claim 4, wherein the anchoring aperture comprises a toggle passage having a length and width slightly larger than a length and thickness of the attachment toggle and
wherein the anchoring aperture comprises a strap passage disposed on opposing lateral sides of the toggle passage the strap passage having a length slightly larger than a width of the first strap portion and a width slightly larger than a thickness of the first strap portion.

6. The harness of claim 5, wherein the length of the toggle passage extends in a direction that forms an acute angle with respect to a longitudinal centerline of the back plate.

7. The harness of claim 5, wherein the attachment toggle is rotated to pass through the toggle passage and un-rotated after passing through the toggle passage to retain the attachment toggle at the anchoring aperture

8. The harness of claim 4, wherein the back plate comprises a plate member,
wherein the anchoring aperture is formed at a portion of the plate member and,
wherein a retaining wall is formed by a series of ridges extending away from a surface of the plate member to a height that is substantially equal to a thickness of the attachment toggle the retaining wall being shaped to extend around a periphery of the attachment toggle to guide and retain the attachment toggle proximate to the plate member.

9. The harness of claim 4, wherein the fixed anchoring points comprise a first anchoring aperture disposed a first distance from a longitudinal centerline of the back plate and a second anchoring aperture disposed a second distance from the longitudinal centerline the first distance being less than the second distance.

10. The harness of claim 1, wherein the attachment toggle is disposed at the selected one of a plurality of fixed anchoring points while the harness is doffed by an operator, and
wherein the adjustable coupler is operable while the harness is donned by the operator.

11. A harness for carrying an outdoor power equipment device, the harness comprising:
a back plate;
a leg plate to support the device responsive to attachment of the device to the leg plate;
a chest buckle operable to alternately enable donning and doffing of the harness; and
an adjustable strap assembly operably coupled to the back plate and the chest buckle to enable a carrying height of the leg plate to be adjusted,
wherein the adjustable strap assembly comprises a strap portion that operably couples the leg plate to the chest buckle via an adjustable coupler that defines an infinite number of set positions for the carrying height of the leg plate.

12. The harness of claim 11, wherein the adjustable coupler comprises a tri-glide slide or webbing slide portion through which the strap portion is passed before selectively engaging a locking slot to alternately the strap portion to be fixed or adjusted.

13. The harness of claim 12, wherein the locking slot comprises a first locking arm and a second locking arm separated from each other by a slip passage, and
wherein the strap portion of the adjustable strap assembly is slidable through the tri-glide slide or webbing slide portion to change the carrying height of the leg plate by pulling an adjustment strap at a distal end of the second strap portion when the adjustment strap is not retained in the locking slot and the carrying height is fixed when the adjustment strap is retained in the locking slot.

14. A harness for carrying an outdoor power equipment device, the harness comprising:
a back plate;
a leg plate to support the device responsive to attachment of the device to the leg plate;
a chest buckle operable to alternately enable donning and doffing of the harness; and
an adjustable strap assembly operably coupled to the back plate and the chest buckle to enable a carrying height of the leg plate to be adjusted,
wherein the adjustable strap assembly comprises a strap portion operably coupling the leg plate to the back plate at a selected one of a plurality of fixed anchoring points via an attachment toggle disposed at a distal end of the first strap portion.

15. The harness of claim 14, wherein each of the fixed anchoring points comprises an anchoring aperture defining a different carrying height corresponding to a different job type performed by the device.

16. The harness of claim 15, wherein the anchoring aperture comprises a toggle passage having a length and width slightly larger than a length and thickness of the attachment toggle, and
wherein the anchoring aperture comprises a strap passage disposed on opposing lateral sides of the toggle passage the strap passage having a length slightly larger than a width of the strap portion and a width slightly larger than a thickness of the strap portion.

17. The harness of claim 16, wherein the length of the toggle passage extends in a direction that forms an acute angle with respect to a longitudinal centerline of the back plate.

18. The harness of claim 16, wherein the attachment toggle is rotated to pass through the toggle passage and un-rotated after passing through the toggle passage to retain the attachment toggle at the anchoring aperture.

19. The harness of claim 15, wherein the back plate comprises a plate member,
wherein the anchoring aperture is formed at a portion of the plate member and,
wherein a retaining wall is formed by a series of ridges extending away from a surface of the plate member to a height that is substantially equal to a thickness of the attachment toggle the retaining wall being shaped to extend around a periphery of the attachment toggle to guide and retain the attachment toggle proximate to the plate member.

20. The harness of claim 15, wherein the fixed anchoring points comprise a first anchoring aperture disposed a first distance from a longitudinal centerline of the back plate and a second anchoring aperture disposed a second distance from the longitudinal centerline, the first distance being less than the second distance.
